(19) United States
(12) Patent Application Publication
(10) Pub. No.: US 2024/0201830 A1
(43) Pub. Date: Jun. 20, 2024

(54) PAGE INTERACTION

(71) Applicant: SHANGHAI BILIBILI TECHNOLOGY CO., LTD., SHANGHAI (CN)

(72) Inventors: Jingyi YAO, SHANGHAI (CN); Yuxuan LIU, SHANGHAI (CN); Hanlin LI, SHANGHAI (CN); Ye LIU, SHANGHAI (CN)

(73) Assignee: SHANGHAI BILIBILI TECHNOLOGY CO., LTD., SHANGHAI (CN)

(21) Appl. No.: 18/493,747

(22) Filed: Oct. 24, 2023

(30) Foreign Application Priority Data
Dec. 20, 2022 (CN) 202211645637.7

(51) Int. Cl. G06F 3/0483; G06F 3/0485; G06F 3/04883

(52) U.S. Cl. CPC G06F 3/0483; G06F 3/0485; G06F 3/04883

(57) ABSTRACT

A page interaction method in provided, where the method includes: displaying a first page in response to a jump instruction for the first page, where the first page includes a first image layer and a second image layer in an expanded state, and the second image layer includes a wishing pool area; in response to detecting that the first page meets a preset entrance condition, displaying the first image layer on the second image layer, and playing a preset entrance special effect in the first image layer; and after the preset entrance special effect is played, canceling display of the first image layer, and playing interactive bullet-screen comments in the wishing pool area of the second image layer through scrolling.

### CROSS-REFERENCE TO RELATED APPLICATION

The present application claims priority to Chinese Patent Application No. 202211645637.7, filed with the China National Intellectual Property Administration on Dec. 20, 2022, which is incorporated herein by reference in its entirety.

### TECHNICAL FIELD

Embodiments of this application relate to the field of computer application technologies, and in particular, to a page interaction method, a computer device, and a non-transitory computer-readable storage medium.

### BACKGROUND

An activity page is generally a page for promoting and introducing a specific product or event, for example, online lottery, product limited-time offers, or task rewards.

### SUMMARY

An aspect of the embodiments of this application provides a page interaction method, including:
displaying a first page in response to a jump instruction for the first page, where the first page includes a first image layer and a second image layer in an expanded state, and the second image layer includes a wishing pool area;
in response to detecting that the first page meets a preset entrance condition, displaying the first image layer on the second image layer, and playing a preset entrance special effect in the first image layer; and
after the preset entrance special effect is played, canceling display of the first image layer, and playing interactive bullet-screen comments in the wishing pool area of the second image layer through scrolling.

An aspect of the embodiments of this application further provides a computer device, where the computer device includes one or more processors; and
a memory, storing one or more programs configured to be executed by the one or more processors, the one or more programs comprising instructions for:
displaying a first page in response to a jump instruction for the first page, wherein the first page comprises a first image layer and a second image layer in an expanded state, and the second image layer comprises a wishing pool area;
in response to detecting that the first page meets a preset entrance condition, displaying the first image layer on the second image layer, and playing a preset entrance special effect in the first image layer; and
after the preset entrance special effect is played, canceling display of the first image layer, and playing interactive bullet-screen comments in the wishing pool area of the second image layer through scrolling.

An aspect of the embodiments of this application further provides a non-transitory computer-readable storage medium, where the non-transitory computer-readable storage medium stores one or more programs comprising instructions that, when executed by one or more processors of a computing device, cause the computing device to perform operations comprising:
displaying a first page in response to a jump instruction for the first page, wherein the first page comprises a first image layer and a second image layer in an expanded state, and the second image layer comprises a wishing pool area;
in response to detecting that the first page meets a preset entrance condition, displaying the first image layer on the second image layer, and playing a preset entrance special effect in the first image layer; and
after the preset entrance special effect is played, canceling display of the first image layer, and playing interactive bullet-screen comments in the wishing pool area of the second image layer through scrolling.

### BRIEF DESCRIPTION OF DRAWINGS

FIG. 1 is a schematic diagram of an application environment of a page interaction method according to some embodiments of this application:

FIG. 2 is a schematic flowchart of a page interaction method according to some embodiments of this application:

FIG. 3 is a schematic diagram of interactive bullet-screen comments displayed in a second image layer according to some embodiments of this application:

FIGS. 4A to 4C are schematic diagrams of an overall procedure of a page interaction method according to some embodiments of this application:

FIG. 5 is a schematic diagram of an effect of a normal layer according to some embodiments of this application:

FIG. 6 is a schematic block diagram of a page interaction system according to some embodiments of this application; and

FIG. 7 is a schematic diagram of a hardware architecture of a computer device suitable for implementing a page interaction method according to some embodiments of this application.

### DETAILED DESCRIPTION OF EMBODIMENTS

To make the objectives, technical solutions, and advantages of this application clearer and more comprehensible, the following further describes this application in detail with reference to the accompanying drawings and embodiments. It should be understood that the specific embodiments described herein are merely used to explain this application but are not intended to limit this application. All other embodiments obtained by a person of ordinary skill in the art based on the embodiments of this application without creative efforts shall fall within the protection scope of this application.

It should be noted that the descriptions “first” and “second” in the embodiments of this application are merely used for description, and shall not be understood as an indication or implication of relative importance or an implicit indication of a quantity of indicated technical features. Therefore, a feature limited by “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of this application.

The inventor of the present application finds that in the conventional technology, because most creative tools on an activity page provide only interactive forms of types such as graphics and text, a video, lottery interaction, task collection, and coupon collection, a display form of interactive content is simple. Consequently, the interactive content displayed on the activity page lacks an immersive atmosphere and an interactive capability of performing content accumulation, resulting in short stay time of a user on the activity page, and a lack of deep interaction with activity information presented on the activity page.

In view of this, this application aims to provide a page interaction solution as follows: displaying a first page in response to a jump instruction for the first page, where the first page includes a first image layer and a second image laver in an expanded state, and the second image layer includes a wishing pool area; when it is detected that the first page meets a preset entrance condition, displaying the first image layer on the second image layer, and playing a preset entrance special effect in the first image layer; and after the preset entrance special effect is played, canceling display of the first image layer, and playing interactive bullet-screen comments in the wishing pool area of the second image layer through scrolling. Immersive bullet-screen comment interaction experience is provided on an activity page, and an interactive form is innovated, so that an effect of rendering an activity atmosphere is achieved. In addition, interactive content comes from the interactive bullet-screen comments posted by a user, thereby implementing highly flexible customized configuration of the interactive content on the activity page, so that a creative tool on a landing page can be used to create complex bullet-screen comment interaction through customized configuration. Therefore, stay time of the user on the activity page is increased, and a probability that the user performs deep interaction with activity information presented on the activity page is increased.

This application provides a plurality of embodiments to further describe the page interaction solution. For details, refer to the following descriptions.

In the descriptions of this application, it should be understood that numerical symbols before steps do not indicate a sequence of performing the steps, but are merely used to facilitate description of this application and differentiation of each step, and therefore cannot be construed as a limitation on this application.

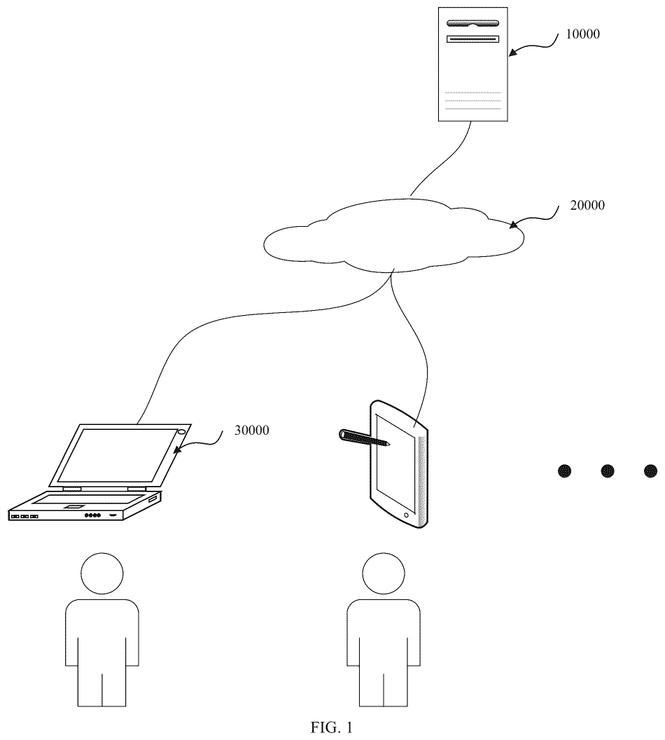

FIG. 1 is a schematic diagram of an application environment according to some embodiments of this application.

As shown in FIG. 1, a computer device 10000 may be connected to a client 30000 by using a network 20000.

The computer device 10000 may provide a service, for example, perform network debugging, or return page interaction result data to the client 30000.

The computer device 10000 may be located in a data center such as a single site, or may be distributed at different geographic locations (for example, in a plurality of sites). The computer device 10000 may provide a service by using one or more networks 20000. The network 20000 includes various network devices such as a router, a switch, a multiplexer, a hub, a modem, a bridge, a repeater, a firewall, and/or a proxy device. The network 20000 may include a physical link, for example, a coaxial cable link, a twisted-pair cable link, an optical fiber link, or a combination thereof. The network 20000 may include a radio link, for example, a cellular link, a satellite link, or a Wi-Fi link.

The computer device 10000 may be implemented by one or more computing nodes. The one or more computing nodes may include virtualized computing instances. The virtualized computing instance may include simulation of a virtual machine such as a computer system, an operating system, or a server. The computing node may load the virtual machine based on a virtual image and/or other data that defines specific software (for example, an operating system, a dedicated application program, or a server) for simulation. As requirements for different types of processing services change, different virtual machines may be loaded and/or terminated on the one or more computing nodes. A management program may be implemented to manage use of different virtual machines on a same computing node.

The client 30000 may be configured to access content and a service of the computer device 10000. The client 30000 may include any type of electronic device, for example, a mobile device, a tablet device, a laptop computer, a workstation, a virtual reality device, a game device, a digital streaming device, a vehicle terminal, a smart television, or a set-top box.

The client 30000 may output (for example, display, render, or present) the page interaction result data or the like to a user.

The following describes a network debugging solution in a plurality of embodiments. The solution may be implemented by using the computer device 10000.

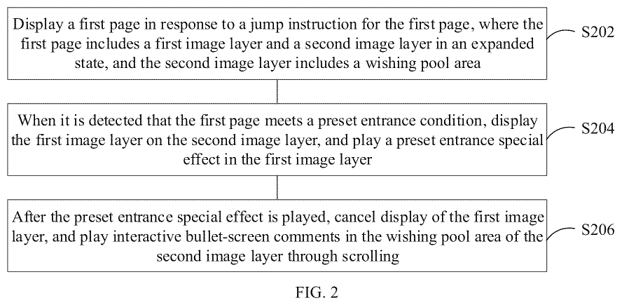

FIG. 2 is a schematic flowchart of a page interaction method according to some embodiments of this application. The method includes steps S202 to S206: Step S202: Display a first page in response to a jump instruction for the first page, where the first page includes a first image layer and a second image layer in an expanded state, and the second image layer includes a wishing pool area.

In the embodiments, the first page may be an activity page or a landing page. A user may initiate a jump instruction for the first page by clicking a uniform resource locator (URL) link or a domain name address of the page. After receiving the jump instruction for the first page, a client displays the first page in response to the jump instruction for the first page.

Specifically, the first page may include a plurality of image layers: the first image layer, the second image layer, and a third image layer. The first image layer may be a pop-up window layer used to play an entrance animation special effect. The second image layer may be a full-screen overlay layer used to display the interactive bullet-screen comments in a form of a wishing pool. The second image layer may be in an expanded state by default, that is, after the first page is entered, the second image layer is first displayed. The third image layer may be a normal layer used to display a page in some common forms in the conventional technology, including a page background image, interactive content (namely, the interactive bullet-screen comments), and the like. The third image layer is displayed only after the second image layer is closed.

Step S204: When it is detected that the first page meets a preset entrance condition, display the first image layer on the second image layer, and play a preset entrance special effect in the first image layer.

The preset entrance condition may be a preset entrance special effect trigger condition. It is detected whether the preset entrance condition is met when the first page is displayed, and when it is detected that the first page meets the preset entrance condition, the first image layer is displayed on the second image layer, and the preset entrance special effect is played in the first image layer. Specifically, the preset entrance special effect may be a preset entrance-related animation special effect. Different animation effects may be separately set for picture content, a size, a location, and playing duration of the entrance special effect based on users with different labels. When playing of the entrance special effect is triggered, label information corresponding to a current user is obtained, a target entrance special effect is determined based on the label information of the user, and the target entrance special effect is played in the first image layer.

In some embodiments of this application, the preset entrance condition includes: display duration of the first page is greater than or equal to preset duration; or a sliding location of a slide operation performed on the second image layer is located in a preset area.

In specific implementation, a timer may be started after the first page is entered, the display duration of the first page is counted by using the timer, and the display duration of the first page is compared with the preset duration. The preset duration is a preset time length, for example, 5 seconds or 10 seconds. This is not specifically limited in the embodiments of this application. If the display duration of the first page is greater than or equal to the preset duration, it is determined that the first page meets the preset entrance condition.

Alternatively, whether the sliding location of the slide operation falls within the preset area is determined by detecting the slide operation performed on the second image layer. The preset area is a preset area range, for example, an area of 20*20 px in an upper right corner. This is not specifically limited in the embodiments of this application. If the sliding location of the slide operation performed on the second image layer falls within the preset area, it is determined that the first page meets the preset entrance condition.

Step S206: After the preset entrance special effect is played, cancel display of the first image layer, and play interactive bullet-screen comments in the wishing pool area of the second image layer through scrolling.

In the embodiments, after the preset entrance special effect is played, the first image layer displayed on the second image layer may be cancelled, and the interactive bullet-screen comments are played in the wishing pool area of the second image layer through scrolling. The interactive bullet-screen comments may be the bullet-screen comment content previously posted by the current user, or may be bullet-screen comment content previously posted by other users.

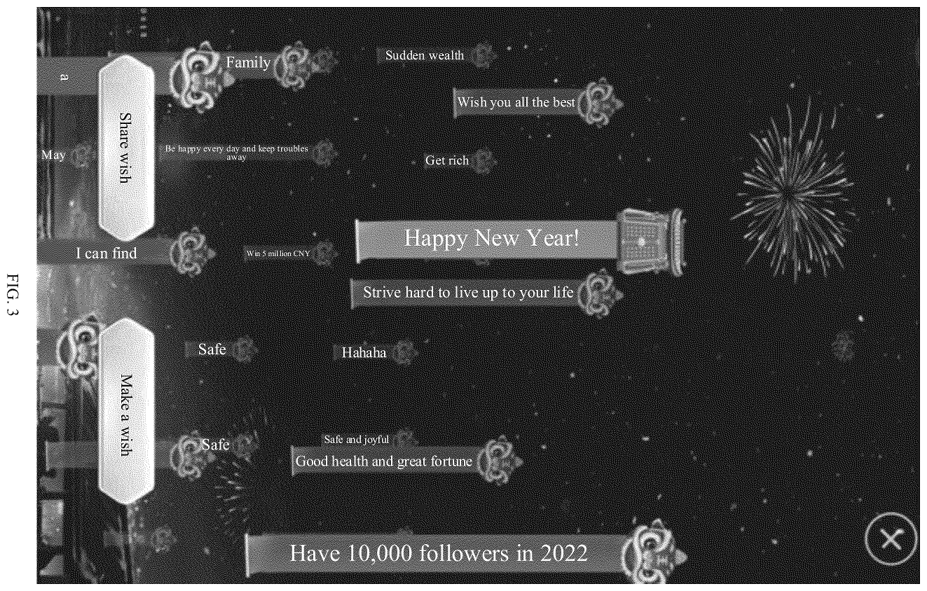

In some embodiments of this application, among the interactive bullet-screen comments, a first bullet-screen comment posted by the current user may be displayed in a first preset style, and second bullet-screen comments posted by other users may be displayed in a second preset style. That is, a style of the interactive bullet-screen comment may be used to distinguish between the first bullet-screen comment posted by the current user and the second bullet-screen comments posted by the other users, and the style may be customized. The first preset style and the second preset style may be a preset display form. In an example, a style of the bullet-screen comment may include a bullet-screen comment direction (such as horizontal or vertical), a prefix icon, a suffix icon, a text background image, a text color, a text font, a text font size, and the like. FIG. 3 is a schematic diagram of interactive bullet-screen comments displayed in a second image layer. “Happy New Year” is the first bullet-screen comment posted by the current user, bullet-screen comments other than “Happy New Year” are the second bullet-screen comments posted by the other users, and “Happy New Year” and the other bullet-screen comments are displayed in different styles. In addition, the second image layer further includes a “Share wish” control and a “Make a wish” control, and the user may share the interactive bullet-screen comments in the wishing pool area on another page by using the “Share wish” control, or may post new interactive content by using the “Make a wish” control.

The following provides several embodiments to optimize the page interaction method, and details are as follows.

In some embodiments of this application, step S204 may include the following steps:
obtaining label information of a current user, searching for target special effect data that matches the label information of the current user; and playing the preset entrance special effect in the first image layer based on the target special effect data.

In the embodiments, corresponding label information may be added to the user by analyzing personal information and a behavior habit of the user, so that different special effect data can be configured for users with different labels. The target special effect data includes picture content information of the special effect, picture size information of the special effect, playing location information of the special effect, and playing duration information of the special effect. This is not specifically limited in the embodiments of this application. When the entrance special effect needs to be played, the label information of the current user is obtained to search for the target special effect data that matches the label information of the current user, and then the preset entrance special effect is played in the first image layer based on the target special effect data.

In the embodiments, the label information includes personal information label of the user or a historical browsing behavior label of the user for the first page. The personal information may be information such as a gender, an age, or a region. The historical browsing behavior for the first page may be behavior data such as behavior data on a previous page of the first page (activity page), whether the current first page (activity page) is entered for the first time, and whether a wishing bullet-screen comment has been posted on the current first page (activity page). This is not specifically limited in the embodiments of this application.

In some embodiments of this application, step S206 may include the following steps:
obtaining posting moments corresponding to the interactive bullet-screen comments; sorting the interactive bullet-screen comments based on the posting moments to obtain a sorting result, and playing the interactive bullet-screen comments in the wishing pool area of the second image layer through scrolling based on the sorting result.

In the embodiments, the posting moments corresponding to all the interactive bullet-screen comments may be obtained, and the interactive bullet-screen comments are sorted based on the posting moments corresponding to the interactive bullet-screen comments, to obtain the sorting result. Then, the interactive bullet-screen comments are played in the wishing pool area of the second image layer through scrolling based on the sorting result.

In some embodiments of this application, the interactive bullet-screen comments in the wishing pool area are presented as a plurality of layers of structures, each layer of structure has a corresponding playing parameter, and step S206 may include the following steps:
playing interactive bullet-screen comments in each layer of structure in the wishing pool area of the second image layer through scrolling based on the playing parameter, so that the interactive bullet-screen comments present a spatial effect of staggered distribution.

In the embodiments, the interactive bullet-screen comments in the wishing pool area are presented as a plurality of layers of structures, and each layer of structure has a corresponding playing parameter. Specifically, the interactive bullet-screen comments in the wishing pool area may include three layers of structures: a front layer, a middle layer, and a back layer, and playing parameters corresponding to all the layers of structures are different. When the interactive bullet-screen comments need to be played, the interactive bullet-screen comments in each layer of structure are played in the wishing pool area of the second image layer through scrolling based on the playing parameter, so that the interactive bullet-screen comments present a spatial effect of staggered distribution. In specific implementation, the first bullet-screen comment posted by the current user may be displayed on the first layer. The second bullet-screen comments posted by the other users are arranged in reverse chronological order, and all the interactive bullet-screen comments are played cyclically.

In some embodiments of this application, the playing parameter includes a motion speed, a motion direction, a bullet-screen comment length, and transparency. Data such as a motion speed, a motion direction, a bullet-screen comment length, and transparency corresponding to each layer of structure are separately configured, so that a sense of spatial distribution is created for a plurality of layers of interactive bullet-screen comments, so as to implement a 3D motion effect.

In some embodiments of this application, the method further includes:
adjusting, in response to a slide operation performed on the wishing pool area of the second image layer, the motion speed based on a sliding direction of the slide operation.

In the embodiments, the user may further perform a slide operation on the wishing pool area of the second image layer, to adjust the motion speed of the interactive bullet-screen comment. In specific implementation, the playing parameters corresponding to all the layers of structures may have a positive correlation relationship. For example, a size of a next layer of interactive bullet-screen comment is obtained by multiplying a size of a current layer of interactive bullet-screen comment by x, a motion speed thereof is obtained by multiplying a motion speed of the current layer of interactive bullet-screen comment by y, and transparency thereof is obtained by multiplying transparency of the current layer of interactive bullet-screen comment by z, where x, y, and z are customized parameters. Therefore, when the motion speed of the interactive bullet-screen comment needs to be adjusted, the motion speeds corresponding to all the layers of structures may be adjusted synchronously based on the sliding direction of the slide operation.

In some embodiments of this application, the adjusting, in response to a slide operation performed on the wishing pool area of the second image layer, the motion speed based on a sliding direction of the slide operation includes:
in response to the slide operation performed on the wishing pool area of the second image layer, reducing the motion speed when the sliding direction of the slide operation is to slide leftward or downward; or in response to the slide operation performed on the wishing pool area of the second image layer, increasing the motion speed when the sliding direction of the slide operation is to slide rightward or upward.

In the embodiments, reverse deceleration may be set, for example, the motion speed is reduced when sliding is performed leftward or downward; or forward acceleration may be set, for example, the motion speed is increased when sliding is performed rightward or upward. In response to the slide operation performed on the wishing pool area of the second image layer, the motion speed is reduced when the sliding direction of the slide operation is to slide leftward or downward; or in response to the slide operation performed on the wishing pool area of the second image layer, the motion speed is increased when the sliding direction of the slide operation is to slide rightward or upward.

It should be noted that, in specific implementation, reverse acceleration may be alternatively set, for example, the motion speed is increased when sliding is performed leftward or downward; or forward deceleration may be alternatively set, for example, the motion speed is reduced when sliding is performed rightward or upward. This is not specifically limited in the embodiments of this application.

In some embodiments of this application, the method may further include the following steps:
in response to a trigger operation performed on a target bullet-screen comment in the interactive bullet-screen comments, displaying a bullet-screen comment pop-up window, and displaying details information corresponding to the target bullet-screen comment in the bullet-screen comment pop-up window.

In the embodiments, the user may perform a trigger operation on the target bullet-screen comment in the interactive bullet-screen comments, to view the details information corresponding to the target bullet-screen comment. The trigger operation may be a tap operation, a double-tap operation, a touch and hold operation, or the like. This is not specifically limited in the embodiments of this application. After receiving the trigger operation performed on the target bullet-screen comment in the interactive bullet-screen comments, in response to the trigger operation, the client displays a bullet-screen comment pop-up window on the second image layer, and displays the details information corresponding to the target bullet-screen comment in the bullet-screen comment pop-up window. The details information corresponding to the target bullet-screen comment may include information such as full text content of the bullet-screen comment, a name of a publisher, an avatar of the publisher, and a wish support value. Certainly, some other related information may be set and displayed based on a requirement. This is not specifically limited in the embodiments of this application.

In some embodiments of this application, the method may further include the following steps:
displaying a support control in the bullet-screen comment pop-up window; and in response to a trigger operation performed on the support control, increasing the wish support value corresponding to the target bullet-screen comment by a preset value.

In the embodiments, the support control may be further displayed in the bullet-screen comment pop-up window. The user may support the target bullet-screen comment by using the trigger operation performed on the support control. The trigger operation may be a tap operation, a double-tap operation, a touch and hold operation, or the like. This is not specifically limited in the embodiments of this application. After receiving the trigger operation performed on the support control, in response to the trigger operation, the client increases the wish support value corresponding to the target bullet-screen comment by the preset value. The preset value is a preset number such as 1, 2, or 5. This is not specifically limited in the embodiments of this application.

In specific implementation, content of the interactive bullet-screen comment is posted and generated by the user, each wishing pool has a unique identifier ID, and all wishing bullet-screen comments in a current wishing pool are associated with an identifier ID of the wishing pool, so that wishing bullet-screen comments in different wishing pools do not affect each other, and wishing bullet-screen comment data in the wishing pool can also be quickly invoked by using the identifier ID.

The wishing pool on the first page can be extended and applied to platform dynamics of an activity planner to implement interaction between a brand account and the user. The unique identifier ID of the wishing pool is used to obtain all the associated wishing bullet-screen comments. Interactive content may be content of comment area of activity dynamics. The wish support value may be a quantity of likes on a comment, and comments are sorted based on the wish support value. During the activity, the activity planner may provide a publisher with a wish support fund as an activity incentive based on the wish support value.

In some embodiments of this application, the method may further include the following steps:
displaying an information storage control in the bullet-screen comment pop-up window; and storing a picture corresponding to the target bullet-screen comment in response to a trigger operation performed on the information storage control.

In the embodiments, the information storage control may be further displayed in the bullet-screen comment pop-up window. The user may store the details information of the target bullet-screen comment by using the trigger operation performed on the information storage control. The trigger operation may be a tap operation, a double-tap operation, a touch and hold operation, or the like. This is not specifically limited in the embodiments of this application. After receiving the trigger operation performed on the information storage control, in response to the trigger operation, the client generates the picture corresponding to the target bullet-screen comment, where the picture includes the details information of the target bullet-screen comment, and stores the picture corresponding to the target bullet-screen comment.

In some embodiments of this application, the method may further include the following steps:
displaying a share control in the bullet-screen comment pop-up window; generating a bullet-screen comment poster corresponding to the target bullet-screen comment in response to a touch operation performed on the share control; and sharing the bullet-screen comment poster on a second page.

In the embodiments, the share control may be further displayed in the bullet-screen comment pop-up window. The user may share the target bullet-screen comment by using the trigger operation performed on the share control. The trigger operation may be a tap operation, a double-tap operation, a touch and hold operation, or the like. This is not specifically limited in the embodiments of this application. After receiving the trigger operation performed on the share control, in response to the trigger operation, the client generates the bullet-screen comment poster corresponding to the target bullet-screen comment, where the bullet-screen comment poster includes the details information of the target bullet-screen comment, and shares the bullet-screen comment poster on the second page. The second page may be a page that is provided in a platform corresponding to the current first page for the user to share dynamic content, or may be a page for information exchange between the current user and another user, or may be a page that is provided in another platform for the user to share dynamic content. This is not specifically limited in the embodiments of this application.

In some embodiments of this application, the second image layer further includes a make-a-wish control, and the method further includes:
displaying a bullet-screen comment input box and a post control in response to a trigger operation performed on the make-a-wish control; receiving, by using the bullet-screen comment input box, a first bullet-screen comment input by a current user; and in response to a trigger operation performed on the post control, playing a preset wishing special effect, and after the preset wishing special effect is played, displaying the first bullet-screen comment in the wishing pool area of the second image layer.

In the embodiments, the second image layer further includes the make-a-wish control, and the make-a-wish control is used by the user to post a new interactive bullet-screen comment. The client may receive the trigger operation performed on the make-a-wish control, for example, a tap operation, a double-tap operation, or a touch and hold operation; display the bullet-screen comment input box and the post control in response to the trigger operation performed on the make-a-wish control; receive, by using the bullet-screen comment input box, the first bullet-screen comment input by the current user; and then in response to the trigger operation performed on the post control, play the preset wishing special effect, and after the preset wishing special effect is played, display the first bullet-screen comment in the wishing pool area of the second image layer. The preset wishing special effect is a preset animation special effect, and is played when the user posts a new bullet-screen comment. In specific implementation, the preset wishing special effect fades out after being played, the first bullet-screen comment just posted by the current user may float out from the first layer of the wishing pool area.

In some embodiments of this application, the second image layer further includes a my-bullet-screen-comment control, and the method further includes:
displaying details information corresponding to the first bullet-screen comment in response to a tap operation performed on the my-bullet-screen-comment control; and displaying, in response to a slide operation performed on the details information corresponding to the first bullet-screen comment, a third bullet-screen comment based on a sliding direction of the slide operation, where the third bullet-screen comment is any bullet-screen comment posted by the current user other than the first bullet-screen comment.

In the embodiments, the second image layer further includes the my-bullet-screen-comment control, and the my-bullet-screen-comment control is used by the current user to view details information of a previously posted bullet-screen comment. The client may receive the trigger operation performed on the my-bullet-screen-comment control, for example, a tap operation, a double-tap operation, or a touch and hold operation, and display the details information corresponding to the first bullet-screen comment in response to the trigger operation performed on the my-bullet-screen-comment control.

In addition, when the details information corresponding to the first bullet-screen comment is displayed, the user may further switch, by using the slide operation performed on the details information corresponding to the first bullet-screen comment, to view another previously posted bullet-screen comment and details information corresponding to the bullet-screen comment. The third bullet-screen comment is displayed based on the sliding direction of the slide operation in response to the slide operation performed on the details information corresponding to the first bullet-screen comment. When the third bullet-screen comment is displayed, details information corresponding to the third bullet-screen comment may be further displayed. The third bullet-screen comment is any bullet-screen comment posted by the current user other than the first bullet-screen comment. Specifically, bullet-screen comments posted by the current user may be sorted based on moments at which the current user posts the bullet-screen comments. When the sliding direction of the slide operation is to slide leftward, a previous bullet-screen comment of the first bullet-screen comment in the sorting order and details information thereof are displayed through switching.

When the sliding direction of the slide operation is to slide rightward, a next bullet-screen comment of the first bullet-screen comment in the sorting order and details information thereof are displayed through switching.

In some embodiments of this application, the first page further includes a third image layer, the second image layer further includes a close control, and the method may further include the following steps:
in response to a trigger operation performed on the close control, hiding the second image layer, and displaying the third image layer on the first page, where the third image layer includes a bullet-screen comment area used to display the interactive bullet-screen comments.

In the embodiments, the first page may further include the third image layer. The second image layer further includes the close control. The client receives the trigger operation performed on the close control, for example, a tap operation, a double-tap operation, and a touch and hold operation; and in response to the trigger operation performed on the close control, hide the second image layer, and display the third image layer on the first page. The third image layer includes the bullet-screen comment area used to display the interactive bullet-screen comments.

In some embodiments of this application, the method may further include the following steps:
displaying the second image layer in response to a trigger operation performed on the bullet-screen comment area of the third image layer.

In the embodiments, the user may further trigger opening of the second image layer by using the trigger operation performed on the bullet-screen comment area, for example, a tap operation, a double-tap operation, and a touch and hold operation. The client displays the second image layer in response to the trigger operation performed on the bullet-screen comment area of the third image layer.

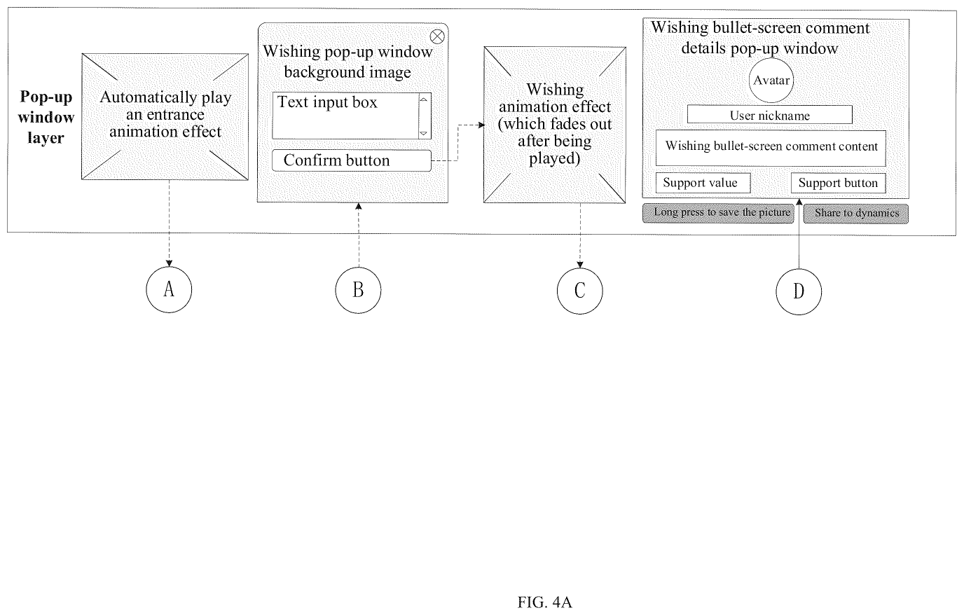

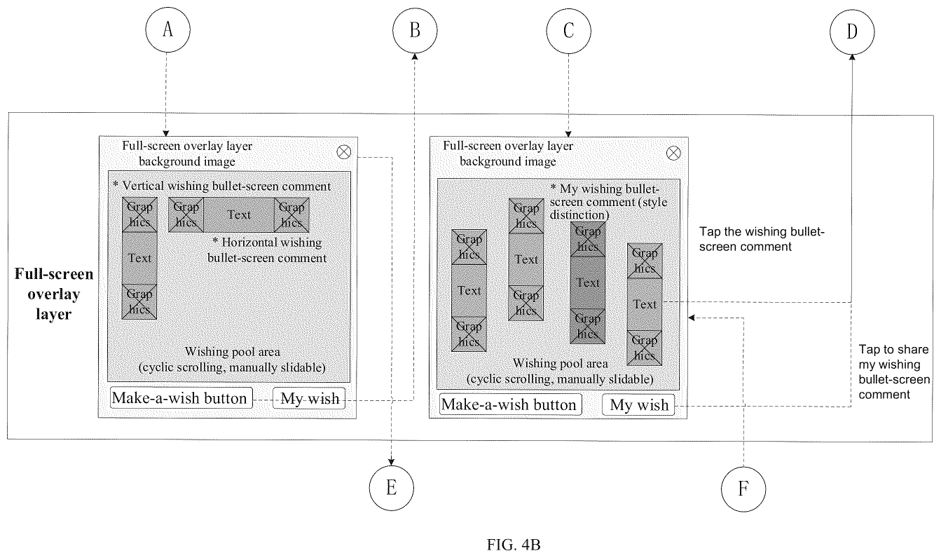

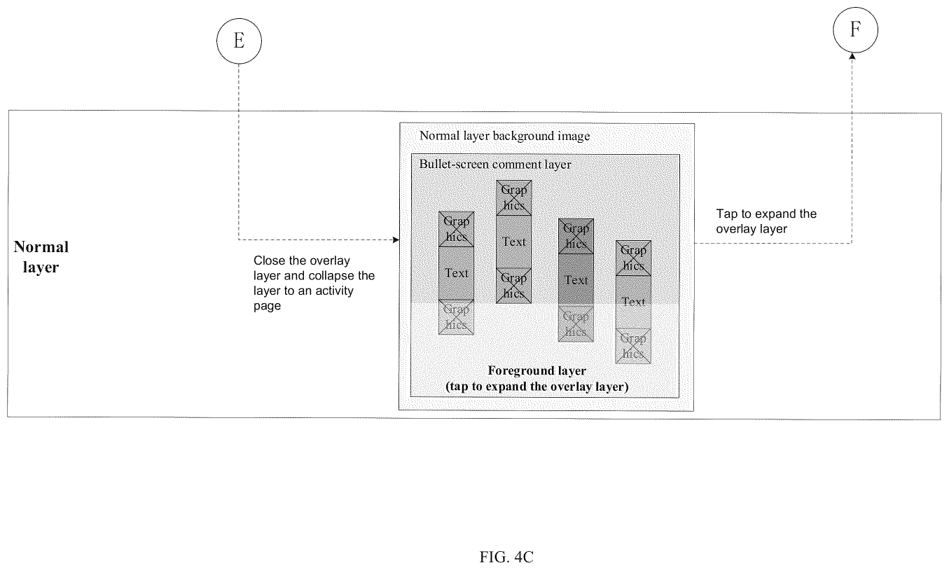

To further describe the page interaction method in the embodiments of this application, FIGS. 4A to 4C illustrate schematic diagrams of an overall procedure of a page interaction method. An activity page (the first page) includes three image layers: a pop-up window layer (that is, the first image layer) as shown in FIG. 4A, a full-screen overlay layer (that is, the second image layer) as shown in FIG. 4B, and a normal layer (that is, the third image layer) as shown in FIG. 4C. The procedure includes the following:
1. A user enters the activity page. The full-screen overlay layer is in an expanded state by default, and the pop-up window layer is triggered to automatically play an entrance animation effect.
2. The entrance animation effect fades out after being played, and the full-screen overlay layer is naturally exposed. The full-screen overlay layer includes four means: a full-screen overlay layer background image, a wishing pool area, a make-a-wish button, and my wish.

The full-screen overlay layer background image may be a background image that is customized by the user and that is adaptive to a screen size.

All wishing bullet-screen comments floating in the wishing pool area present a 3D motion effect, are cyclically played through scrolling, and may specifically include a vertical wishing bullet-screen comment and a horizontal wishing bullet-screen comment. These wishing bullet-screen comments are cyclically played through scrolling, and a playing speed of the wishing bullet-screen comment may be adjusted through manual sliding.

Make-a-wish button: The make-a-wish button may be tapped to trigger display of a wishing pop-up window, including a wishing pop-up window background image, a text input box, and a confirm button. The user inputs wishing content by using the text input box, and after the user taps the confirm button and posts the content, a wishing animation effect is automatically played, and the wishing animation effect fades out after being played. In this case, a wishing bullet-screen comment just posted floats out from the first layer of the wishing pool area. The wishing procedure is completed.

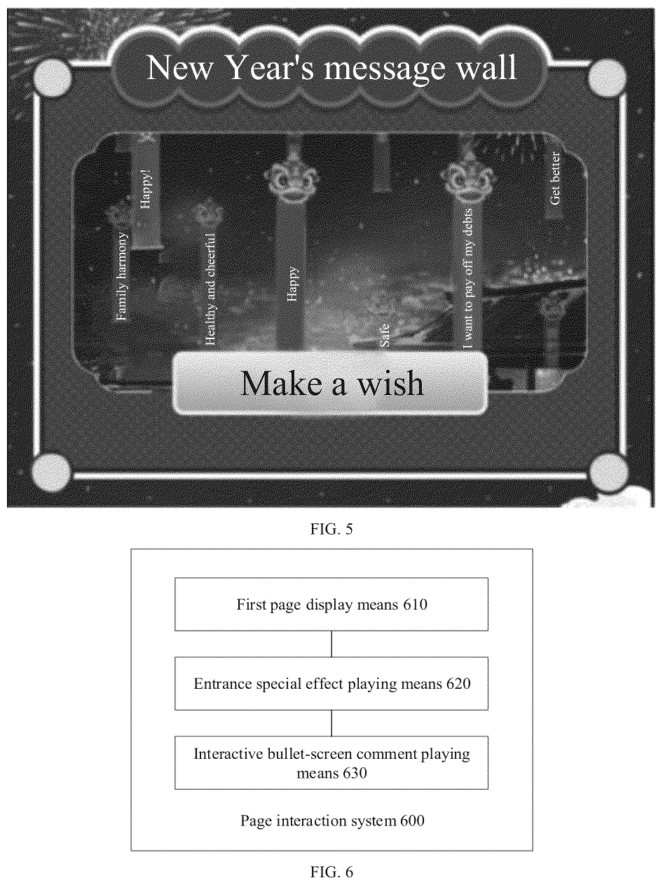

My-wish control: The my-wish control may be tapped to display a details pop-up window of a newest wishing bullet-screen comment posted by the current user. The details pop-up window may be slid leftward or rightward to switch to another wishing bullet-screen comment posted by the current user.
3. The full-screen overlay layer includes a close button. The user may tap the close button of the full-screen overlay layer to collapse the full-screen floating layer to the normal layer. Alternatively, the user may tap the wishing pool area of the normal layer to expand the full-screen overlay layer again. A width and a height of the wishing pool of the normal layer can be customized. A background layer and foreground layer of the wishing pool of the normal layer can be set to be integrated into an overall design style of the activity page. Display logic of a wishing bullet-screen comment in the wishing pool of the normal layer is the same as that in the full-screen overlay layer, and the wishing bullet-screen comment in the wishing pool of the normal layer and the wishing pool area of the full-screen overlay layer can be continuously played. FIG. 5 is a schematic diagram of an effect of a normal layer. The normal layer may include a foreground layer, a wishing pool area, and a background layer. Interactive bullet-screen comments are displayed in the wishing pool area. The normal layer may further include a “Make a wish” button. The user can post new interactive content by tapping the “Make a wish” button.

FIG. 6 is a schematic block diagram of a page interaction system according to some embodiments of this application. The page interaction system may be divided into one or more program means. The one or more program means are stored in a storage medium, and are executed by one or more processors, to complete the embodiments of this application. The program means in the embodiments of this application is a series of computer program instruction segments that can be used to complete a specified function. The following specifically describes a function of each program means in the embodiments of this application.

As shown in FIG. 6, the page interaction system 600 may include the following means:
a first page display means 610, configured to display a first page in response to a jump instruction for the first page, where the first page includes a first image layer and a second image layer in an expanded state, and the second image layer includes a wishing pool area;
an entrance special effect playing means 620, configured to: when it is detected that the first page meets a preset entrance condition, display the first image layer on the second image layer, and play a preset entrance special effect in the first image layer; and
an interactive bullet-screen comment playing means 630, configured to: after the preset entrance special effect is played, cancel display of the first image layer, and play interactive bullet-screen comments in the wishing pool area of the second image layer through scrolling.

In some embodiments, the preset entrance condition includes:
display duration of the first page is greater than or equal to preset duration; or
a sliding location of a slide operation performed on the second image layer is located in a preset area.

In some embodiments, the entrance special effect playing means 620 includes:
a label information obtaining sub-means, configured to obtain label information of a current user;
a target special effect data matching sub-means, configured to search for target special effect data that matches the label information of the current user; and
an entrance special effect playing sub-means, configured to play the preset entrance special effect in the first image layer based on the target special effect data.

In some embodiments, the target special effect data includes picture content information of the special effect, picture size information of the special effect, playing location information of the special effect, and playing duration information of the special effect.

In some embodiments, the label information includes personal information label of the user or a historical browsing behavior label of the user for the first page.

In some embodiments, the interactive bullet-screen comment playing means 630 includes: a posting moment obtaining sub-means, configured to obtain posting moments corresponding to the interactive bullet-screen comments;
an interactive bullet-screen comment sorting sub-means, configured to sort the interactive bullet-screen comments based on the posting moments to obtain a sorting result; and
a first playing sub-means, configured to play the interactive bullet-screen comments in the wishing pool area of the second image layer through scrolling based on the sorting result.

In some embodiments, the interactive bullet-screen comments in the wishing pool area are presented as a plurality of layers of structures, each layer of structure has a corresponding playing parameter, and the interactive bullet-screen comment playing means 630 includes:
a second playing sub-means, configured to play interactive bullet-screen comments in each layer of structure in the wishing pool area of the second image layer through scrolling based on the playing parameter, so that the interactive bullet-screen comments present a spatial effect of staggered distribution.

In some embodiments, the playing parameter includes a motion speed, a motion direction, a bullet-screen comment length, and transparency.

In some embodiments, the system further includes:
a motion speed adjustment means, configured to adjust, in response to a slide operation performed on the wishing pool area of the second image layer, the motion speed based on a sliding direction of the slide operation.

In some embodiments, the motion speed adjustment means includes:
a first speed adjustment sub-means, configured to: in response to the slide operation performed on the wishing pool area of the second image layer, reduce the motion speed when the sliding direction of the slide operation is to slide leftward or downward; or
a second speed adjustment sub-means, configured to: in response to the slide operation performed on the wishing pool area of the second image layer, increase the motion speed when the sliding direction of the slide operation is to slide rightward or upward.

In some embodiments, the system further includes:
a details information display means, configured to: in response to a trigger operation performed on a target bullet-screen comment in the interactive bullet-screen comments, display a bullet-screen comment pop-up window, and display details information corresponding to the target bullet-screen comment in the bullet-screen comment pop-up window.

In some embodiments, the details information corresponding to the target bullet-screen comment includes:
full text content of the bullet-screen comment, a name of a publisher, an avatar of the publisher, and a wish support value.

In some embodiments, the system further includes:
a support control display means, configured to display a support control in the bullet-screen comment pop-up window; and
a support value increase means, configured to: in response to a trigger operation performed on the support control, increase the wish support value corresponding to the target bullet-screen comment by a preset value.

In some embodiments, the system further includes:
an information storage control display means, configured to display an information storage control in the bullet-screen comment pop-up window; and
a bullet-screen comment picture storage means, configured to: store a picture corresponding to the target bullet-screen comment in response to a trigger operation performed on the information storage control.

In some embodiments, the system further includes:
a share control display means, configured to display a share control in the bullet-screen comment pop-up window;
a bullet-screen comment poster generation means, configured to generate a bullet-screen comment poster corresponding to the target bullet-screen comment in response to a touch operation performed on the share control; and
a bullet-screen comment poster sharing means, configured to share the bullet-screen comment poster on a second page.

In some embodiments, the second image layer further includes a make-a-wish control, and the system further includes:
a bullet-screen comment input box display means, configured to display a bullet-screen comment input box and a post control in response to a trigger operation performed on the make-a-wish control;
a first bullet-screen comment receiving means, configured to receive, by using the bullet-screen comment input box, a first bullet-screen comment input by a current user; and
a first bullet-screen comment display means, configured to: in response to a trigger operation performed on the post control, play a preset wishing special effect, and after the preset wishing special effect is played, display the first bullet-screen comment in the wishing pool area of the second image layer.

In some embodiments, the second image layer further includes a my-bullet-screen-comment control, and the system further includes:
a details information display means of the first bullet-screen comment, configured to display details information corresponding to the first bullet-screen comment in response to a tap operation performed on the my bullet-screen comment control; and
a second bullet-screen comment display means, configured to display, in response to a slide operation performed on the details information corresponding to the first bullet-screen comment, a third bullet-screen comment based on a sliding direction of the slide operation, where the third bullet-screen comment is any bullet-screen comment posted by the current user other than the first bullet-screen comment.

In some embodiments, among the interactive bullet-screen comments, a first bullet-screen comment posted by a current user is displayed in a first preset style, and second bullet-screen comments posted by other users are displayed in a second preset style.

In some embodiments, the first page further includes a third image layer, the second image layer further includes a close control, and the system further includes:
a third image layer display means, configured to: in response to a trigger operation performed on the close control, hide the second image layer, and display the third image layer on the first page, where the third image layer includes a bullet-screen comment area used to display the interactive bullet-screen comments.

In some embodiments, the system further includes:
a second image layer display means, configured to display the second image layer in response to a trigger operation performed on the bullet-screen comment area of the third image layer.

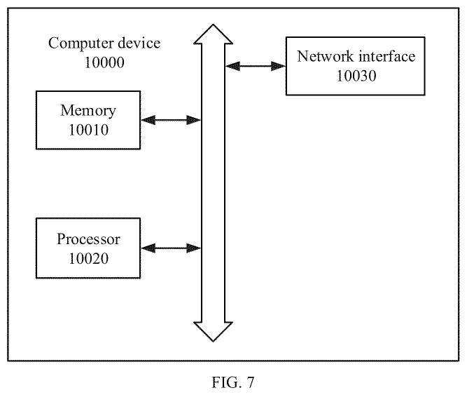

FIG. 7 is a schematic diagram of a hardware architecture of a computer device 10000 suitable for implementing a page interaction method according to some embodiments of this application. In the embodiments, the computer device 10000 is a device that can automatically calculate a value and/or process information based on an instruction that is set or stored in advance. For example, the computer device 10000 may be a smartphone, a tablet computer, a notebook computer, a desktop computer, a rack server, a blade server, a tower server, or a cabinet server (including a FEN independent server, or a server cluster including a plurality of servers). As shown in FIG. 7, the computer device 10000 at least includes but is not limited to a memory 10010, a processor 10020, and a network interface 10030 that can be communicatively connected to each other by using a system bus.

The memory 10010 includes at least one type of computer-readable storage medium. The readable storage medium includes a flash memory, a hard disk, a multimedia card, a card-type storage (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 10010 may be an internal storage means of the computer device 10000, for example, a hard disk or a memory of the computer device 10000. In some other embodiments, the memory 10010 may alternatively be an external storage device of the computer device 10000, for example, a plug-in hard disk, a smart media card (SMC), a secure digital (SD) card, or a flash card that is disposed on the computer device 10000. Certainly, the memory 10010 may include both an internal storage means of the computer device 10000 and an external storage device of the computer device 10000. In the embodiments, the memory 10010 is usually configured to store an operating system and various types of application software that are installed on the computer device 10000, for example, program code of the page interaction method. In addition, the memory 10010 may be further configured to temporarily store various types of data that have been output or are to be output.

The processor 10020 may be a central processing unit (CPU), a controller, a microcontroller, a microprocessor, or another data processing chip in some embodiments. The processor 10020 is usually configured to control an overall operation of the computer device 10000, for example, perform control and processing related to data exchange or communication performed by the computer device 10000. In the embodiments, the processor 10020 is configured to run program code stored in the memory 10010 or process data.

The network interface 10030 may include a wireless network interface or a wired network interface, and the network interface 10030 is usually configured to establish a communication link between the computer device 10000 and another computer device. For example, the network interface 10030 is configured to: connect the computer device 10000 to an external terminal by using a network, and establish a data transmission channel, a communication link, and the like between the computer device 10000 and the external terminal. The network may be a wireless or wired network such as an Intranet, the Internet, a global system for mobile communications (GSM), wideband code division multiple access (WCDMA), a 4G network, a 5G network, Bluetooth, or Wi-Fi.

It should be noted that FIG. 7 shows only a computer device with the components 10010 to 10030. However, it should be understood that implementation of all the shown components is not required, and more or fewer components may be alternatively implemented.

In the embodiments, the page interaction method stored in the memory 10010 may be further divided into one or more program means to be executed by one or more processors (the processor 10020 in the embodiments), to complete the embodiments of this application.

The embodiments of this application provides a computer-readable storage medium. The computer-readable storage medium stores a computer program. When the computer program is executed by a processor, steps of the page interaction method in the embodiments are implemented.

In the embodiments, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or a memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may include both an internal storage unit of the computer device and an external storage device of the computer device. In the embodiments, the computer-readable storage medium is generally configured to store an operating system and various application software that are installed on the computer device, for example, program code of the page interaction method in the embodiments. In addition, the computer-readable storage medium may be further configured to temporarily store various types of data that have been output or are to be output.

Clearly, a person skilled in the art should understand that the foregoing means or steps in the embodiments of this application may be implemented by using a general computing apparatus. The means or steps may be integrated into a single computing apparatus or distributed in a network including a plurality of computing apparatuses. In some embodiments, the means or steps may be implemented by using program code that can be executed by the computing apparatus. Therefore, the means or steps may be stored in a storage apparatus for execution by the computing apparatus. In addition, in some cases, the shown or described steps may be performed in an order different from the order herein. Alternatively, the means or steps may be separately made into integrated circuit means, or a plurality of means or steps in the means or steps are made into a single integrated circuit means for implementation. In this way, a combination of any specific hardware and software is not limited in the embodiments of this application.

The foregoing descriptions are merely embodiments of this application, and are not intended to limit the scope of this application. Any equivalent structure or equivalent procedure change made based on the content of this specification and the accompanying drawings of this application is directly or indirectly applied to other related technical fields, and shall fall within the protection scope of this application.

What is claimed is:

1. A page interaction method, comprising:
displaying a first page in response to a jump instruction for the first page, wherein the first page comprises a first image layer and a second image layer in an expanded state, and the second image layer comprises a wishing pool area;
in response to detecting that the first page meets a preset entrance condition, displaying the first image layer on the second image layer, and playing a preset entrance special effect in the first image layer; and
after the preset entrance special effect is played, canceling display of the first image layer, and playing interactive bullet-screen comments in the wishing pool area of the second image layer through scrolling.

2. The page interaction method according to claim 1, wherein the preset entrance condition comprises:
display duration of the first page is greater than or equal to preset duration; or
a sliding location of a slide operation performed on the second image layer is located in a preset area.

3. The page interaction method according to claim 1, wherein the playing the preset entrance special effect in the first image layer comprises:
obtaining label information of a current user;
searching for target special effect data that matches the label information of the current user; and
playing the preset entrance special effect in the first image layer based on the target special effect data.

4. The page interaction method according to claim 3, wherein the label information comprises personal information label of the user or a historical browsing behavior label of the user for the first page.

5. The page interaction method according to claim 1, wherein the playing the interactive bullet-screen comments in the wishing pool area of the second image layer through scrolling comprises:
obtaining posting moments corresponding to the interactive bullet-screen comments;
sorting the interactive bullet-screen comments based on the posting moments to obtain a sorting result; and
playing the interactive bullet-screen comments in the wishing pool area of the second image layer through scrolling based on the sorting result.

6. The page interaction method according to claim 1, wherein the interactive bullet-screen comments in the wishing pool area are presented as a plurality of layers of structures, each layer of structure has a corresponding playing parameter, and the playing the interactive bullet-screen comments in the wishing pool area of the second image layer through scrolling comprises:
playing interactive bullet-screen comments in each layer of structure in the wishing pool area of the second image layer through scrolling based on the playing parameter, so that the interactive bullet-screen comments present a spatial effect of staggered distribution.

7. The page interaction method according to claim 6, wherein the playing parameter comprises a motion speed, and the method further comprises:
adjusting, in response to a slide operation performed on the wishing pool area of the second image layer, the motion speed based on a sliding direction of the slide operation.

8. The page interaction method according to claim 7, wherein the adjusting, in response to the slide operation performed on the wishing pool area of the second image layer, the motion speed based on the sliding direction of the slide operation comprises:
in response to the slide operation performed on the wishing pool area of the second image layer, reducing the motion speed in accordance with a determination that the sliding direction of the slide operation is to slide leftward or downward; or
in response to the slide operation performed on the wishing pool area of the second image layer, increasing the motion speed in accordance with a determination that the sliding direction of the slide operation is to slide rightward or upward.

9. The page interaction method according to claim 1, further comprising:
in response to a trigger operation performed on a target bullet-screen comment in the interactive bullet-screen comments, displaying a bullet-screen comment pop-up window, and displaying details information corresponding to the target bullet-screen comment in the bullet-screen comment pop-up window.

10. The page interaction method according to claim 9, wherein the details information comprises a wish support value, and the method further comprises:
displaying a support control in the bullet-screen comment pop-up window; and
in response to a trigger operation performed on the support control, increasing the wish support value corresponding to the target bullet-screen comment by a preset value.

11. The page interaction method according to claim 9, further comprising:
displaying an information storage control in the bullet-screen comment pop-up window; and
storing a picture corresponding to the target bullet-screen comment in response to a trigger operation performed on the information storage control.

12. The page interaction method according to claim 9, further comprising:
displaying a share control in the bullet-screen comment pop-up window;
generating a bullet-screen comment poster corresponding to the target bullet-screen comment in response to a touch operation performed on the share control; and
sharing the bullet-screen comment poster on a second page.

13. The page interaction method according to claim 1, wherein the second image layer further comprises a make-a-wish control, and the method further comprises:
displaying a bullet-screen comment input box and a post control in response to a trigger operation performed on the make-a-wish control;
receiving, by using the bullet-screen comment input box, a first bullet-screen comment input by a current user; and
in response to a trigger operation performed on the post control, playing a preset wishing special effect, and after the preset wishing special effect is played, displaying the first bullet-screen comment in the wishing pool area of the second image layer.

14. The page interaction method according to claim 13, wherein the second image layer further comprises a my-bullet-screen-comment control, and the method further comprises:
displaying details information corresponding to the first bullet-screen comment in response to a tap operation performed on the my-bullet-screen-comment control; and
displaying, in response to a slide operation performed on the details information corresponding to the first bullet-screen comment, a third bullet-screen comment based on a sliding direction of the slide operation, wherein the third bullet-screen comment is any bullet-screen comment posted by the current user other than the first bullet-screen comment.

15. The page interaction method according to claim 1, wherein among the interactive bullet-screen comments, a first bullet-screen comment posted by a current user is displayed in a first preset style, and second bullet-screen comments posted by other users are displayed in a second preset style.

16. The page interaction method according to claim 1, wherein the first page further comprises a third image layer, the second image layer further comprises a close control, and the method further comprises:
in response to a trigger operation performed on the close control, hiding the second image layer, and displaying the third image layer on the first page, wherein the third image layer comprises a bullet-screen comment area used to display the interactive bullet-screen comments.

17. The page interaction method according to claim 16, further comprising:
displaying the second image layer in response to a trigger operation performed on the bullet-screen comment area of the third image layer.

18. A computer device, wherein the computer device comprises;
one or more processors; and
a memory, storing one or more programs configured to be executed by the one or more processors, the one or more programs comprising instructions for:
displaying a first page in response to a jump instruction for the first page, wherein the first page comprises a first image layer and a second image layer in an expanded state, and the second image layer comprises a wishing pool area;
in response to detecting that the first page meets a preset entrance condition, displaying the first image layer on the second image layer, and playing a preset entrance special effect in the first image layer; and
after the preset entrance special effect is played, canceling display of the first image layer, and playing interactive bullet-screen comments in the wishing pool area of the second image layer through scrolling.

19. The computer device according to claim 18, wherein the preset entrance condition comprises:
display duration of the first page is greater than or equal to preset duration; or
a sliding location of a slide operation performed on the second image layer is located in a preset area.

20. A non-transitory computer-readable storage medium, wherein the non-transitory computer-readable storage medium stores one or more programs comprising instructions that, when executed by one or more processors of a computing device, cause the computing device to perform operations comprising:
displaying a first page in response to a jump instruction for the first page, wherein the first page comprises a first image layer and a second image layer in an expanded state, and the second image layer comprises a wishing pool area;
in response to detecting that the first page meets a preset entrance condition, displaying the first image layer on the second image layer, and playing a preset entrance special effect in the first image layer; and
after the preset entrance special effect is played, canceling display of the first image layer, and playing interactive bullet-screen comments in the wishing pool area of the second image layer through scrolling.
